(19) United States
(12) Patent Application Publication
(10) Pub. No.: US 2008/0077854 A1
(43) Pub. Date: Mar. 27, 2008

(54) GENERATION, DOCUMENTATION AND PRESENTATION OF MATHEMATICAL EQUATIONS AND SYMBOLIC SCIENTIFIC EXPRESSIONS USING PURE HTML, CSS, AND JAVASCRIPT

(75) Inventor: KEHINDE ALABI, ROCKY POINT, NY (US)

Correspondence Address: KEHINDE ALABI, 110 FRIENDSHIP DRIVE, ROCKY POINT, NY, 11778, US

(73) Assignee: KEHINDE ALABI, ROCKY POINT, NY (US)

(21) Appl. No.: 11/534,679

(22) Filed: Sep. 25, 2006

(51) Int. Cl. G06F 17/00

(52) U.S. Cl. 715/236; 715/267; 715/255; 715/234; 715/227

(57) ABSTRACT

A comprehensive method for representing mathematical equations and symbolic scientific expressions using pure HTML and CSS is disclosed. This method renders the equations portable and editable and contrasts with previous procedures that represent equations using a single graphic object. A method of generating the equations using HTML and JavaScript is also disclosed. Finally, a procedure for documenting the equations within the HTML document is included such that the equations can be interpreted and converted to and from other formats such as LaTex, MATHML, or linear representation.

### REFERENCES CITED

U.S. Patent Documents

| | | | |
|---|---|---|---|
| 6,922,200 | July 2005 | Marques | 345/619 |
| 6,795,838 | September 2004 | Kataoka | 708/160 |
| 5,189,633 | February 1993 | Eisendrath et. al. | 708/142 |
| 20060059214 | March 2006 | Murray et. al. | 708/160 |
| 10/882,811 | July 2004 | Alabi | 345/744 |
| 11,306,355 | December 2005 | Alabi | 434/322 |

### OTHER PUBLICATIONS

Donald E. Knuth, The TeXbook, Reading Mass., Addison Wesley 1984
Leslie Lamport, LaTeX: A Document Preparation System, User's Guide & Reference Manual, 2^{nd} Ed., Addison Wesley, 1994.
Murray Sargent III, Unicode Nearly Plain-Text Encoding of Mathematics, Unicode Technical Note 4/2006.
Hutchinson, T_{T}H: a “TeX to HTML” Translator, Vr. 3.43. http://hutchinson.belmont.ma.us/tth/manual/ 4/2001.
Davies, J., et. al., “Knowledge Discovery and Delivery”, British Telecommunications Engineering, London, GB, vol. 17, No. 1, Apr. 1, 1998, pp. 25-35, XP-000765546.
Goker, A., “Capturing Information Need by Learning User Context”, 16^{th} International Joint Conference in Artificial Intelligence: Learning About User Workshop, Jul. 31, 1999, pp. 21-27, XP-002205013.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, TABLE, OR A COMPUTER PROGRAM LISTING COMPACT DISK, APPENDIX

Not Applicable

### BACKGROUND OF THE INVENTION

The current invention pertains to the generation, documentation, and presentation of mathematical equations and symbolic scientific expressions. In particular, the invention is aimed at solving the well known problem of the presentation of mathematical equations and scientific notation on the World Wide Web.

Previous practice of the art of presenting equations within web pages has been guided by the belief that HTML which is the dominant basic mode of presentation over the Internet is not able to perform this function in its native form. Consequently, presentation of mathematical equations within web pages has been accomplished mainly in the following two ways.

In the first method, equations are created with an application or tool and converted into graphic files which are embedded within the HTML page. This method suffers from the fact that graphic files are usually larger than text files or pure HTML files resulting in slower presentation of the pages. Secondly, once converted into graphic form, the equations are not easily editable or modifiable on the presentation computer. In fact in most cases, one has to have access to or ownership of a copy of the generation application to edit the equation.

In the second method, java applets are downloaded to the client or viewing computer and generate the equations on the same. This method also suffers from the additional applet download time and requires every client computer accessing the presentation page to download the applet. The extra requirement is a significant inconvenience as the number of computers with this applet would need to be considerable for the entire scheme to retain one of the biggest advantages of presenting material over the Internet—the lack of any burden on the user to install additional software in general.

The MATHML standard was devised by the W3C—the body that governs standards related to Internet documents and applications—to address this problem. The first specification was released in July 1999 and prescribes solutions both to the problem of presentation as well as that of documentation of mathematical notation. Several years since this release the problem remains unresolved for the several reasons:

The MATHML specification describes equations through a comprehensive set of XML tags. As a result, the format is almost impossible to author directly and additional tools and programs to edit the format are required.

MATHML is quite verbose and bulky. This can be attributed to the attempt by the standard to not only address the problem of presentation but that of documentation as well. The consequence of this would reflect on the download time of HTML pages that include MATHML equations.

The MATHML specification like Java applet presentation of mathematical equations require the client to either download applications that can present the format or have the format natively supported in all browsers. At this point, a majority of browsers still do not support this format and the process of adoption is a long way off.

There have been other efforts to display mathematical equations and symbolic scientific expression in pure HTML format. Most notable is the TTH LaTex to HTML application which translates LaTex equations into equations using only HTML syntax and fonts. However, the resulting equations aesthetically do not compare well with graphic equivalents generated in LaTex or other more traditional equation presentation medium.

Advances in HTML and web development technology leads us to believe that the assumption of the inability of pure HTML to present equations acceptably needs to be revisited. In particular, the so-called AJAX technology combining HTML, CSS, Javascript and XML provide new opportunities to handle the generation and presentation of dynamic and more complicated content than was previously possible. For instance, support for UNICODE fonts and symbols have recently been utilized in enhancing the presentation of mathematical equations in linear form. An example is the work of Sargent et. al. (2004).

Marques (2005) showed that HTML alone can be used in presenting small graphics and charts without generating memory-intensive or bulky graphics as was the practice in prior art. The additional challenge with extending this or the linear format procedure to equations is that true presentation of equations requires a “built-up” form which requires additional processing. Innovative approaches and modification have to be developed taking advantage of some of the recent advances in HTML and AJAX technology. This is the approach in the current invention.

### BRIEF SUMMARY OF THE INVENTION

Disclosed is a comprehensive description of format and procedures to display mathematical equations and symbolic scientific expression using mainly pure HTML elements to present the same in built-up form. The format or standard includes methods to additionally document the equations within the HTML resource in a manner that makes the equations editable or interpretable so that they are exportable to other formats such as LaTex, MATHML or UNICODE linear format.

In addition, using JavaScript and HTML, the procedure and format describes methods of creating or generating the equations in real-time.

For presentation of equations, the current method uses a comprehensive sequence of tables, table rows, and table cells with intuitive merging and splitting of cells to present built-up equations in HTML form. Each table which is part of an equation is referred to as an equation table, each row an equation row, and each cell an equation cell.

Symbols and parts of the representation may include small graphic symbols or UNICODE characters that are part of the HTML font library. Note that when small graphic symbols are used, this is distinct from the wholesale representation of the equation as graphics or bitmap as is currently practiced. Individual graphic symbols are handled in the same manner as font elements (some of which are really native small graphics) and can be manipulated as a unit, making editable an equation including such symbols.

Aspects of cascading styles (CSS) or simply styles associated with the HTML tags and modifying their appearance is used in influencing the rendering of the equations in graphic manner comparable to that obtained from LaTex and traditional equation processing tools in prior art. The style elements include those that influence the text spacing, text appearance as well as background characteristics of the equation tables and cells.

For generation, the current method discloses HTML and JavaScript client-side procedures to generate, modify, and manage the HTML equation elements and symbols. Symbols may be inserted via selection from a menu containing the symbols. Note that even though HTML client-side procedures are described for generating and modifying the equations, this is not to be construed as the limit of the generation and modification process in the current invention. In fact, one familiar with the art may easily recognize that the HTML equation presentation method described in this invention can be implemented in several ways including the preferred embodiment contained here.

Processes for editing and modifying equations follow naturally from the above since HTML equations are generated directly in a built-up form consisting of unit elements and symbols contained in distinct equation cells. Individual symbols and elements may be added or deleted and in fact the entire equation may be edited in place in a manner that is more flexible than traditional methods of generating equations including LaTex and MATHML.

For documentation, a set of names and identities are attached to each equation cell, row, or table to describe its content. A comprehensive notation scheme is devised sufficient to allow any application (not only web browsers) to extract the HTML content of equations as text and interpret the equations and/or convert them into another format such as LaTex or MATHML.

### BRIEF DESCRIPTION OF THE DRAWINGS

FIG. 1 is a diagram that illustrates the table and cell representation of fractions as well as combined subscript and superscripts.

FIG. 2 is a diagram that illustrates the table and cell representation of matrices as well as vertical limiters.

FIG. 3 is a diagram that illustrates the table and cell representation of horizontal decorations as well as square roots or the n-th radical.

FIG. 4 is a diagram that illustrates the table and cell representation of the n-ary operator as well as stacks in equations.

FIG. 5 is a diagram that illustrates the table and cell representation of equation cases as well as equation arrays.

FIG. 6 demonstrates the labeling of equations as well as the use of spacer cells to position equations. The figure also includes a example of pure HTML text for a sample equation.

FIG. 7 includes a comparison of the HTML equations generated using the current invention compared to traditional equation presentation methods in which equations are represented as whole graphics.

FIG. 8 includes an illustration of a sample HTML equation editor and the results of editing a sample document in the editor.

### DETAILED DESCRIPTION OF THE INVENTION

In the unit level, the elements of an HTML equation in the current disclosure consist of symbols and operators. Symbols may include fonts and small bits of graphics representing symbols and may include UNICODE symbols where supported by the browser. The symbols and operators have spacing and appearance that is distinct from ordinary text elements of an HTML presentation.

This presentation requirement is effected by applying and attaching an appropriate style to the equation cell, row, or table. The style may be implemented as a separate cascading style sheet (CSS) or contained directly within the HTML resource containing the equation. In particular, setting text spacing and font style will cause the presentation of symbol and mathematical text to have an appearance desired for scientific symbol and mathematical expression. The font format can also be set directly or portions of an equation cell which are desired to be text or have a text-like appearance can be individually selected and set to text format.

Built-up portions of an equation include elements such as fractions, subscripts, superscripts, matrices, roots, variable size limiters, and decorations such as overbar and underbars. These items are referred to as built-up because of the two-dimensional requirements for their presentation as opposed to linear text which proceeds linearly either from left to right or the reverse. For instance, fractions may be presented as a numerator placed directly over a denominator. The procedure for presenting built-up equation elements are presented next.

In the current disclosure, an expression will subsequently refer to at least one symbol or a combination of symbols which may be considered an equation in its own right.

Fractions

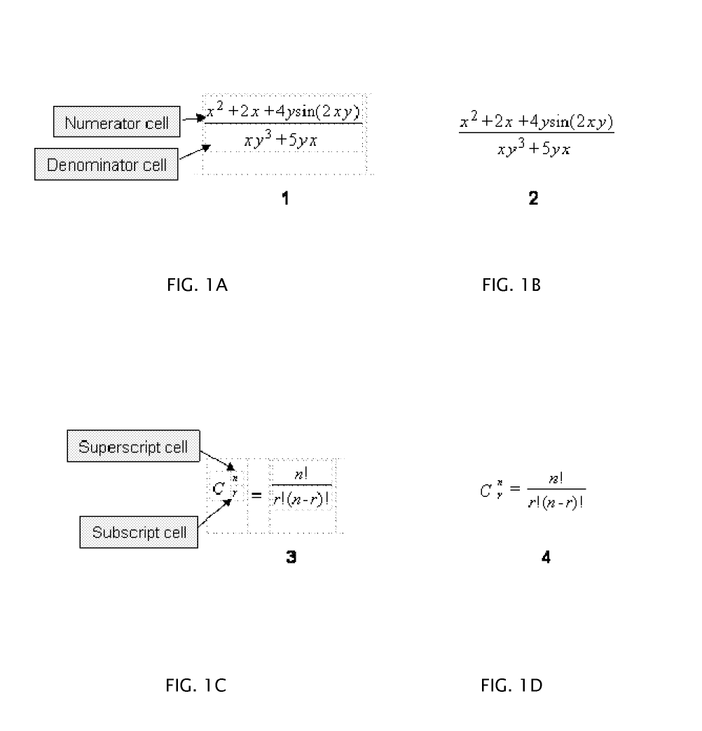

A fraction may be represented by two equation rows (table rows in HTML) in sequence, one on top of the other. The numerator expression will be contained in the top row and the denominator expression in the bottom row 1. This is illustrated in FIG. 1A with dotted borderlines displayed in table cells for clarity (and access to cells in edit mode). FIG. 1 B shows the built-up equations without the cell borders 2.

Superscript and Subscripts

HTML already renders subscripts and superscripts well when either occurs alone. For combined subscript and superscripts, the argument or symbol to which the superscript and subscript applies is contained in a cell. The cell next to it is split into two rows. The top cell contains the superscript expression aligned to the top and left of the cell while the subscript expression is contained in the bottom row and aligned to the bottom and left of the cell 3. This is illustrated in FIG. 1C with the cell borders indicated with dotted lines while FIG. 1D shows the cells with the borders removed 4. The text size in the subscript and superscript cells are set to a smaller size than the default expression text size.

Matrices

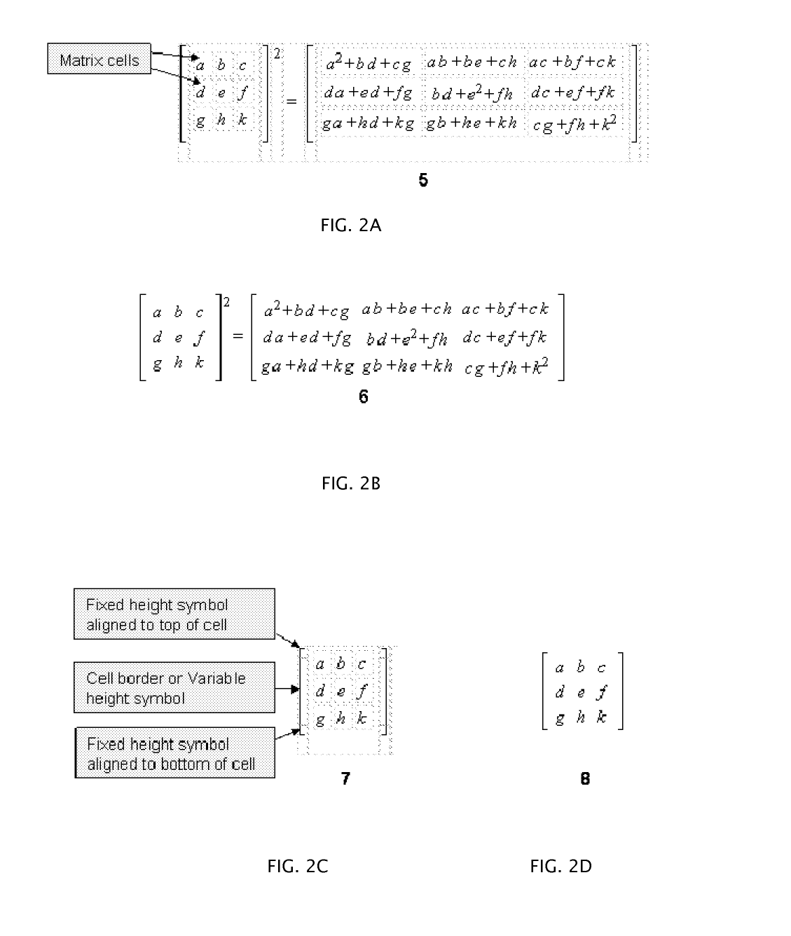

Matrices are represented as an HTML table containing as many rows and columns 5 as there are rows and columns in the matrix. This is illustrated in FIG. 2A with the cell borders indicated with dotted lines while FIG. 2B shows the cells with the borders removed 6.

Limiters

Limiters are contained in cells that span the rows of their arguments 7. Each cell is then composed of a limiter table strategically composed so that the limiter has variable size. In the illustration in FIG. 2C 7, the square bracket is composed of three symbols in three table cells. The top and bottom cells contain the top and bottom symbols respectively, are fixed and form the tips of the square bracket. The middle cell uses a border and has a variable size such that the entire limiter has a variable height. This is illustrated in FIG. 2C with the cell borders indicated with dotted lines while FIG. 2D shows the cells with the borders removed 8. A similar scheme is devised for curly brackets, angle brackets and rounded brackets appropriately using different symbols and table composition to admit a variable limiter size for these elements.

Decorations

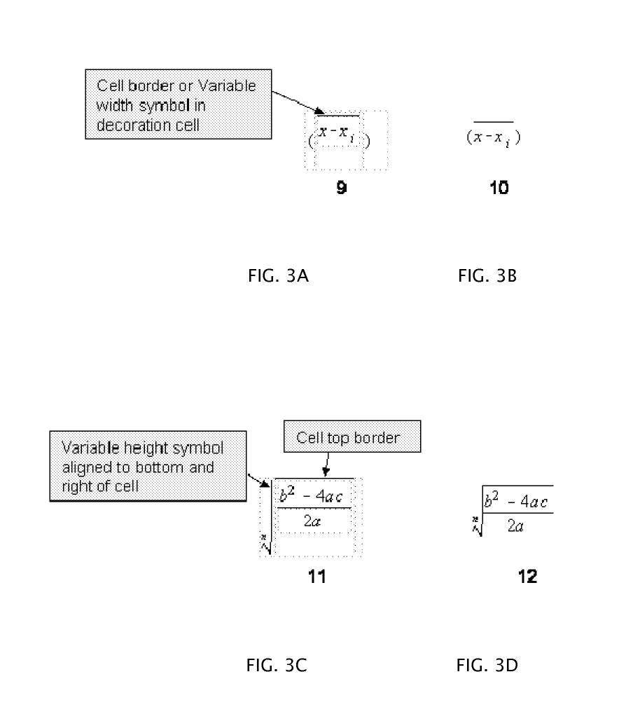

Decorations are expression elements such as overbar (usually denoting average of the variable or expression), dots above, accents, or acute symbol over a variable or expression. Decorations are developed similar to limiters except that in this case the decorations span the columns of the expressions they cover. The table representing decorations are also constructed in a manner that makes them variable in size. In FIG. 3A, the overbar is simply constructed using the border of the decoration table 9. This is illustrated in FIG. 3A with the cell borders indicated with dotted lines while FIG. 3B shows the cells with the borders removed 10. The decoration table may also contain several columns each containing a symbol such that the entire mosaic forms the decoration.

Square Roots and Radicals

A root or radical is represented by two adjacent cells in a row. The left cell contains the radical number and its background image is set to the root symbol aligned to the right and bottom of the cell 11. (No radical number is displayed for the square root.) The image is constructed such that it is extremely long making it variable in height with respect to the cell. By aligning the background image to the bottom of the cell, the kink of the root is always appropriately positioned regardless of the height of the arguments. The cell on the right is set with a top border which naturally coincides with the top line of the background image in the left cell 11. This is illustrated in FIG. 3C with the cell borders indicated with dotted lines while FIG. 3D shows the cells with the borders removed 12. The text in the cell containing the root value is set to the same size as for subscripts and superscripts.

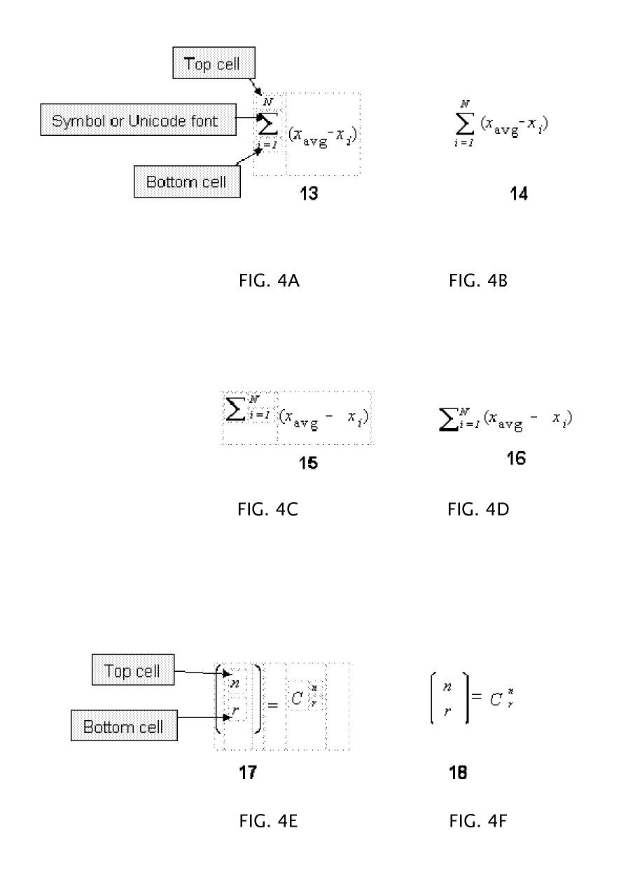

n-ary Operators n-ary operators include mathematical elements or symbols for summation, product, and integral and are thus referred because they may contain more than two operands. FIG. 4A uses the summation operator to illustrate the HTML representation of these kinds of operators 13. In this figure, the cell borders are indicated with dotted lines for clarity while FIG. 4B shows the cells with the borders removed 14. Essentially, the operator contains a symbol and the limit operands are placed in cells above and below the operator symbol cell. The third operand, the summand or summation argument, is contained in the cell to the right of the operator symbol. n-ary operators may also be displayed with the limit arguments placed to the right of the operator. In this case, the procedure for handling subscripts and superscripts is used 15 as illustrated in FIG. 4C. The operator is properly presented as illustrated in FIG. 4D when the cell borders are removed 16.

Stacks

Stacks are parts of an expression that include two sub-expressions positioned vertically; similar to a fraction but without a visual line separating them. In the current disclosure, stacks are processed similar to a single column, two row matrix. This is illustrated in Figure 4E with the cell borders indicated with dotted lines 17 while FIG. 4F shows the cells with the borders removed 18.

Text Within Expressions

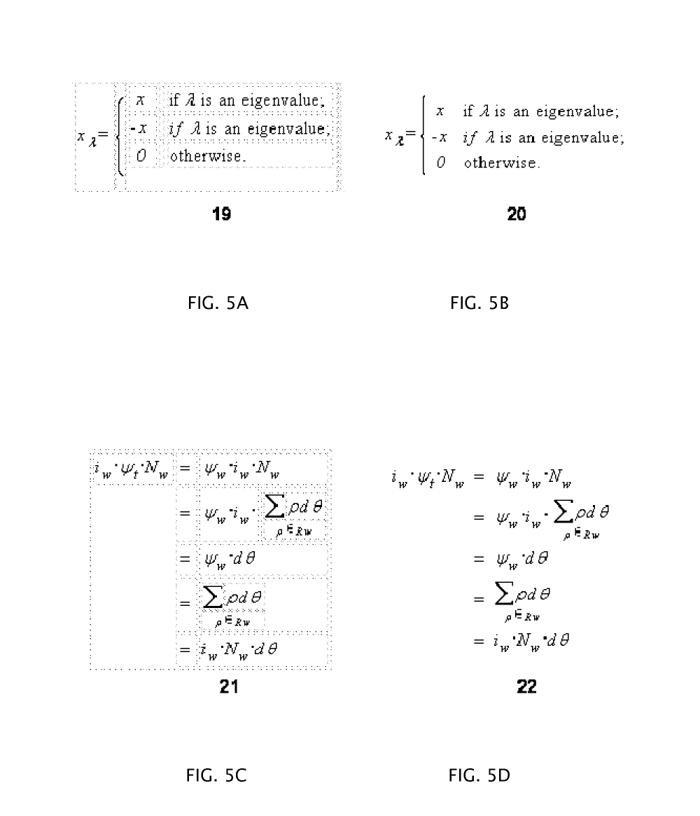

Ordinary text may be placed within expressions by taking advantage of HTML's own advanced text management abilities. The styles (CSS) of the text elements within the expressions are simply modified to obtain the desired text look as opposed to the math look of the rest of the equation. This is illustrated in FIG. 5A 19.

Spaces Within Expressions

Handling of spaces is easier in the current disclosure than most traditional methods of presenting equations. Spaces can be directly inserted as desired within expressions and within cells using the free-form ability of HTML.

Cases, Equation Arrays, and Other Equation Features

Cases are expressions usually consisting of a row of sub-expressions, each with a condition stating the range and/or validity of the sub-expression. Cases may be handled in the same manner as a single column, multiple row matrix. This is illustrated in FIG. 5A with the cell borders indicated with dotted lines 19 while FIG. 5B shows the cells with the borders removed 20. Equation arrays are rows of equations usually with one expression on the left, connected through several operators to multiple expressions on the right. Equation arrays are handled in the same manner as cases as illustrated in FIG. 5C with borders used to indicate the HTML cells 21. FIG. 5D shows the equation without the graphic cell borders 22. Other equation elements may simply be developed in the same built-up method as disclosed above utilizing the free-form ability of HTML table cells combined with regular HTML text, styles, and symbols as well as one or more of the expression elements such as fractions, matrices, etc. described above.

Nested Built-up Elements

Nested elements follow naturally from all the various expression or equation elements presented above. This is due to the fact that each cell in a built-up sequence is essentially an equation cell in its own right and can itself accommodate any of the built-up sequences described above. For instance, a matrix can be placed inside a fraction HTML cell or a fraction placed inside the HTML numerator cell of a parent fraction and so on. This is illustrated in FIGS. 3C, 3D, 5C, and 5D. In FIG. 3, a fraction is placed inside a root HTML cell, while in FIG. 5, n-ary operators are placed inside HTML “matrix” or equation array sub cells. An inheritance rule is implemented within nested elements such that nested cells may acquire certain properties of or as a result of properties of their parent cells. For instance, all expressions nested within a superscript or subscript cell acquire the superscript or subscript property while subscript and superscript of subscripts or superscripts are assigned font sizes even smaller than those of their parent cells.

Spacing and Labeling of Equations

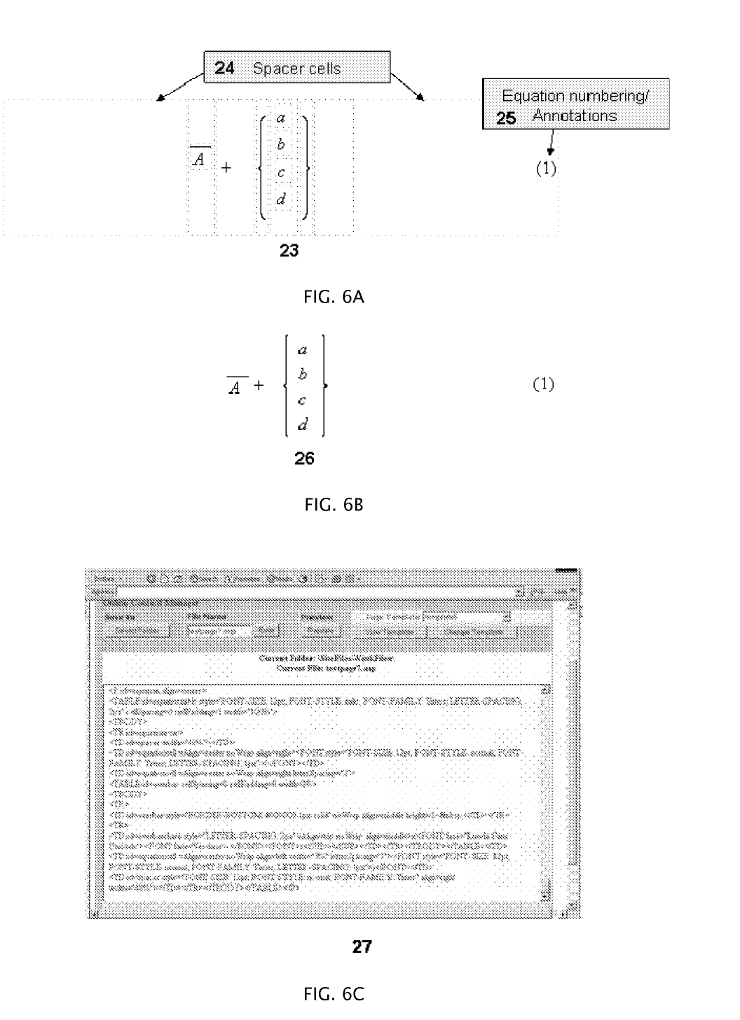

Appropriate spacing of equations is achieved for equation zones by implementing a character spacing style for all elements of the equation (text areas override this style by simply applying a separate style to text symbols). To achieve a tight fit of expressions within cells such that there are no gaps between them across the cells, the current embodiment enforces a “no wrap” style on HTML equation cells such that the cell expands to the exact fit of the expressions contained within it. A separate embodiment may simply apply the exact cell width as measured by the content of the cell and adjust for different text size setting within different browsers. However, as can be perceived by one familiar with the art, the current embodiment has the advantage of portability of equations and expressions. FIG. 6 illustrates the procedure for labeling and spacing an equation zone or an equation contained within its own line in a document 23. For equation zones, two extra cells of equal size, referred to as spacer cells 24, are used to fit the equations to the center of the document. The right equation cell is style formatted such that a label for the equation 25 may be entered within it as presented in FIG. 6A with borders included for illustration. FIG. 6B shows the equation and label with the borders removed 26. For equations contained within the text of a document, the equation table may simply be inserted without the spacer cells or the entire row extracted into a table with text in cells to the left and/or right of the equation cells depending on the positioning of the equation along the line.

FIG. 6C presents the pure HTML text of the equation in FIG. 2A. There are two alternative methods to represent the final equations. In one embodiment, each equation cell, text zones, and element may be addressed by a style with the style definition contained in a separate portion of the document or in a completely different document. In the embodiment illustrated in FIG. 6C the actual styles are applied directly to the HTML tags. This method is more verbose than the first which contains smaller, easier-to-read HTML but has the advantage of portability. Equations generated in this format may be highlighted on a web page and simply copied and pasted to a different HTML document and the entire look and presentation of the equation will be preserved. (Note from the figure that the entire equation is pure HTML and can be directly edited in an HTML or browser editor.) The duplicate equation may then be modified or edited directly resulting in mathematical and scientific equations that are truly portable across the World Wide Web.

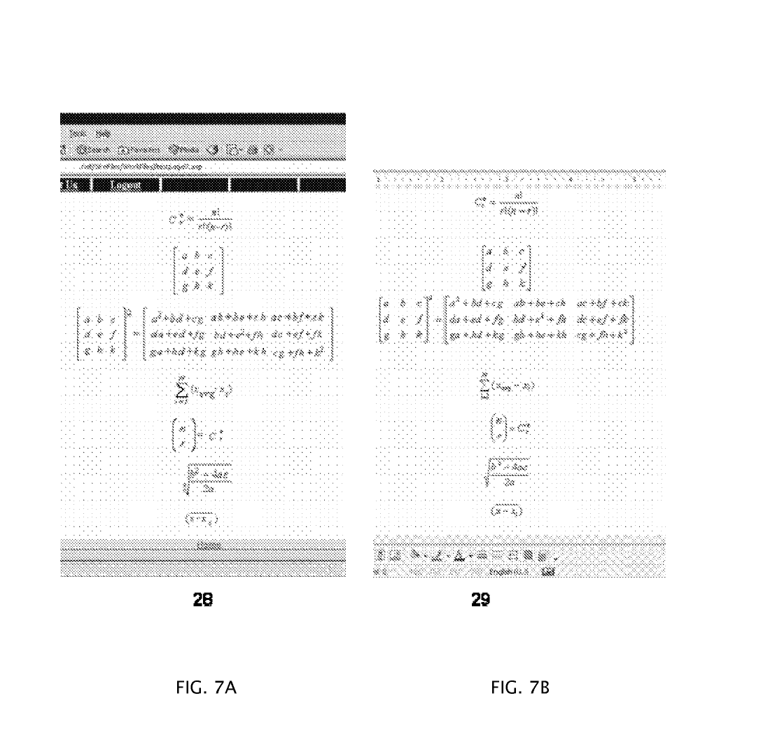

Finally, FIG. 7 shows a number of equations presented in the pure HTML format disclosed in the current invention compared to equations presented in graphic form in a desktop publishing software, which is a dominant method of presenting mathematical equations and scientific expressions in prior art. FIG. 7A contains the set of equations in editable HTML form while FIG. 7B is the graphic equivalent. The figure shows the ability of the HTML form to render equations about as successfully as the graphic equivalent—the measure being the accurate and aesthetically pleasant presentation of built-up mathematical equations and scientific expressions in a two-dimensional document.

Generating and Editing HTML Equations

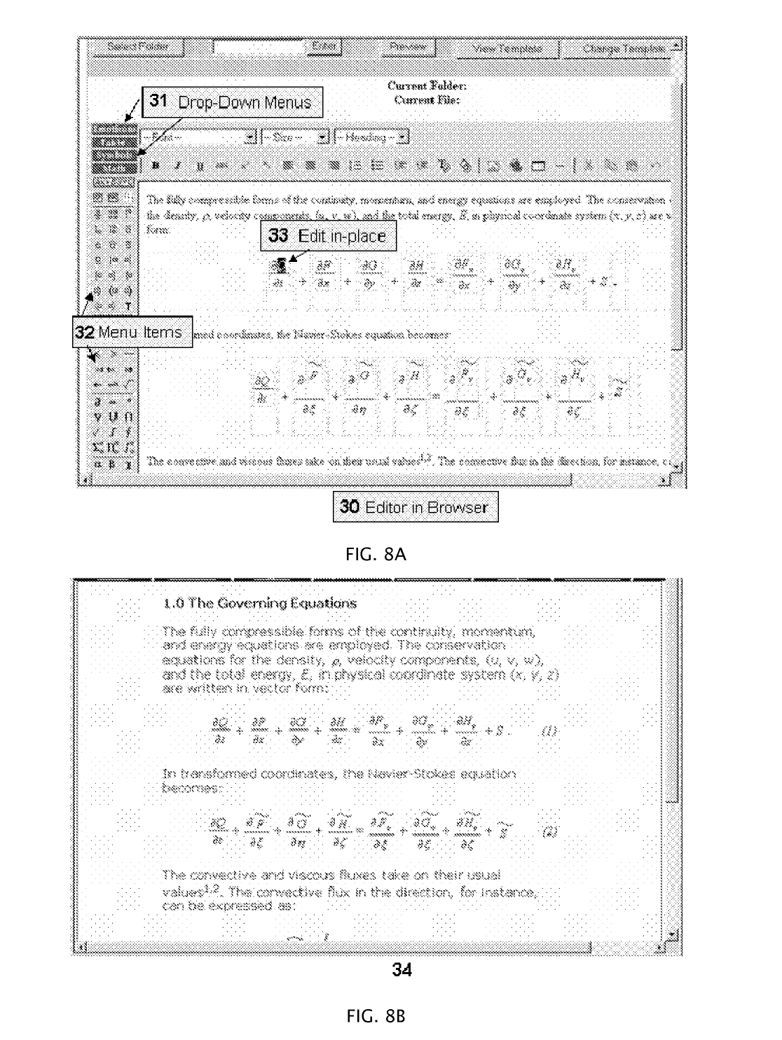

Following the description of how HTML can be used to present mathematical equations and scientific expressions, one familiar with the art may easily deduce that generating such equations simply requires an application that can create the sequence of built-up HTML tables and cells representing the equations. There are many application development tools capable of being used to perform this task. However, in the current embodiment, we have utilized JavaScript and HTML alone. This is not to be construed as limiting the current invention. The elegance of the HTML generation tools disclosed in detail here is the fact that both the generation mechanism as well as the presentation of HTML equations are accomplished in the HTML environment (online in real-time, if required) using procedures available on most browsers without the need to purchase, download, or install additional software. A sample interface 30 illustrating features that the generation tool may contain is presented in FIG. 8A.

The HTML generation application consists of a sequence of menus that can be activated by the user 31. Each menu may further contain items that can be invoked to generate or modify an aspect of an HTML equation. Associated with the click of the menus or any other events related to them are JavaScript programs or instructions that cause the manipulation of the equation (or a part of it) in the generation or editing area 33. The generation area could be the HTML page, a separate HTML page, or a frame in an HTML page. The JavaScript instructions act by modifying the HTML content in the generation area. For instance, clicking the fraction button causes the insertion of the fraction table as described previously in the section for the presentation of fractions within HTML cells. An additional instruction may cause the cursor to be positioned within the numerator cell implicitly prompting the user for the numerator expression. In general, the javascript instruction may contain one or more of the following instructions:

commands to determine the position of the current cell within the context of the entire equation including to determine the parent cell and/or neighbor cells

commands to build or modify a section of HTML to present an equation according to the rules disclosed for presenting HTML equations including those for inheritance for nested cells.

commands to position the cursor appropriately following the build-up or modification of the equation.

In addition, certain rules are implemented when a sub-expression is selected while a menu item is activated. As an example, for fractions, if a sub-expression is selected and the fraction button is activated, the sub-expression is extracted, the fraction cells are inserted, and the sub-expression is placed inside the numerator cell.

Due to the fact that the editor is implemented directly in HTML, the other parts of the documents as well as the equations may be directly edited. Spaces may be added as needed, symbols may be inserted from the keyboard or pasted from other documents or from the computer memory, new cells, may be added, split or merged as desired, and almost any HTML format may be applied within the equation. FIG. 8B, for instance, shows the result of editing 34 the content presented in the edit area of FIG. 8A.

Documenting HTML Equations

Documentation of HTML equations is an integral part of the current invention. This was included so that the HTML contents of the current equation can be organized in form that allows their content to be interpreted and converted to other formats including Tex, LaTex, MATHML or Linear format.

Documentation is accomplished by taking advantage of the tagged nature of HTML itself. A further qualification of HTML is the fact that tags may be named or provided identification. As a result, the tags of the equation cells may be named such that the type of contents of the cells may be determined from the name of the cells. The following names, as an example, are a part of the current HTML disclosure:

| Element | Name |
|---|---|
| Fraction table | frac |
| Matrix table | matrix |
| Numerator cell | numerator |
| Denominator cell | denominator |
| Superscript cell | superscript |
| Subscript cell | subscript |
| Left square limiter cell | leftsqbrac |
| Right square limiter cell | rightsqbrac |
| Left curly limiter cell | leftcurlybrac |
| Right curly limiter cell | rightcurlybrac |
| Left angle limiter cell | leftanglebrac |
| Right angle limiter cell | rightanglebrac |
| Left bracket cell | leftbrac |
| Right bracket cell | rightbrac |
| Square root table | sqrt |
| Sum operator table | sum |
| Integral operator table | int |
| Product operator table | prod |
| Overbar cell | overbar |
| Dot on characters cell | overdot |
| Braces over characters cell | overbrace |
| Accent over characters cell | overaccent |
| Spacer cell | spacer |

One familiar with the current art may notice that some of the names are derived from commands in prior art such as in LaTex. This is simply to facilitate the easy development of converters to or from traditional equation forms.

Once the type of contents of a cell is determined, the exact contents of the cell may simply be determined directly from the HTML contents of the cell—since HTML equations are basically made up of texts and symbols. Further, the symbol images that are used to build the expressions are given names or filenames that have a descriptive order. For instance, the image used for the symbol “±” (if image symbols are used rather than Unicode or other font representation) is math_pm.gif (similar to \pm used in LaTex). Finally, named styles are also provided descriptive names. For instance, the text style is named math_text. Together, the entire content of HTML equations as disclosed here may be completely interpreted from the HTML text alone.

What is claimed is:

1. A method of representing mathematical equations and symbolic scientific expression such that the equations and expressions are rendered in built-up mathematical form in a web browser. This method additionally includes the following parts:
representing the equations using the following elements—fonts, small graphics, small background graphics, or other hypertext markup language (HTML) parts;
representing the entire equation in a system of one or more HTML table cells in HTML tables, where any of the cells may span one or more rows and/or columns, each cell containing none to several elements including fonts, small graphics, or small background graphics, or other HTML parts;
representing parts of the equations within sub tables each also containing a system of HTML table cells, where any of the cells may span one or more rows and/or columns, each cell containing none to several elements—the combination being used to form a sub-expression within the equation;
representing aspects of the equations within sub tables containing a system of HTML table cells containing some fonts, small graphics, or small background graphics appropriately aligned within the cell, where any or more of the cells may span one or more rows and/or columns—the combination being used to form a mosaic of a specific scientific or mathematical symbol;
representing the equations in a system of cells which may further contain nested equation HTML tables or cells containing sub-equation parts or sub-expressions;
using zero to more table cells with relative or specific sizes to fit the equation within the HTML tables;
Formatting equation cells with none to several specific cascading sheet styles (CSS) causing the equations within the cells to be rendered in scientific or mathematical form;
Setting up the nested equation cells such that they may inherit specific characteristics of or due to their parent cells.

2. The method of claim 1 where at least one cell of the HTML equation table cells includes a cell spanning more than one row or column or includes a visually highlighted border or contains a sub table comprising a system of HTML table cells containing some fonts, small graphics, or small background graphics appropriately aligned within the cell, where any or more of the cells may span one or more rows and/or columns—the combination being used to form a mosaic of a specific scientific or mathematical symbol.

3. A method of generating the mathematical equations and symbolic scientific expression in HTML using an application containing the following parts:
An editing area represented as a region in which the HTML equation is being generated or modified
Menus containing icons that can be activated to generate or modify a part or all of the equation in the edit area;
Routines and programs that causes a response to the icon and menu events to generate or modify a part or all of the equation according to the method in claim 1;

4. The method of claim 3 in which the equations or expressions are generated using the following elements—fonts, small graphics, small background graphics, or other hypertext markup language (HTML) parts.

5. The method of claim 3 in which the equations or expressions are generated in a system of one or more HTML table cells in HTML tables, where any of the cells may span one or more rows and/or columns, each cell containing none to several elements including fonts, small graphics, or small background graphics, or other HTML part.

6. A method of documenting the HTML parts of a mathematical equation or symbolic scientific expression composed of HTML tags, fonts, and small graphics pieces in a system of HTML table cells consisting of a set of documentation format and rules that are complete enough to enable the entire content of the equation or expression to be interpreted from its HTML representation. This documentation method additionally includes:
Formats for describing the contents of cells through the cell name or identification;
Formats for naming the styles applied to the HTML elements of the equation or expression.
Formats for naming the small graphic pieces contained in the equation or expression.
Formats for naming the image files that form a part or all of a symbol in the equation or expression.
